(19) United States
(12) Patent Application Publication
(10) Pub. No.: US 2003/0139155 A1
(43) Pub. Date: Jul. 24, 2003

(54) Self-power generation type transmitter

(76) Inventor: Yasuhiro Sakai, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/282,241

(22) Filed: Oct. 29, 2002

(30) Foreign Application Priority Data
Oct. 29, 2001 (JP) 2001-331634

(51) Int. Cl. H04B 1/04; H04B 1/02

(52) U.S. Cl. 455/127; 455/91

(57) ABSTRACT

In a self-power generation type transmitter, piezoelectric elements are used as a power source for transmission and generated power is efficiently utilized so that the transmission of a signal requiring a relatively high electric power can be performed. The self-power generation type transmitter includes a power generating part 2 for generating electric power by applying distortion to piezoelectric elements 21, a charging part 3 for repeatedly charging generated power, and a transmitting part 4 for transmitting a signal by the charged power. When an amount of charged power reaches a level at which the signal can be transmitted, the electric power is supplied to the transmitting part from the charging part.

### TECHNICAL BACKGROUND OF THE INVENTION

1. Technical Field to which the Invention Belongs

The present invention relates to a transmitter using piezoelectric elements as a power source.

2. Prior Art

A piezoelectric effect for converting the mechanical energy and electrical energy of a piezoelectric material has been hitherto well-known. A technique that the piezoelectric material is changed to an element to make use of the piezoelectric material and the element is employed as a piezoelectric element has been developed. In the present condition, although various kinds of materials such as ceramic materials have been examined and promoted to be put to practical use as the piezoelectric elements, a sufficient quantity of power generation cannot be obtained.

As a technique that this piezoelectric element is employed as a power source of a transmitter, a “transmitter” is disclosed in Japanese Patent Application Laid-Open No. hei 5-037404 in which a transmitter using a piezoelectric element as well as a primary battery as a power source is proposed. In the publication, is disclosed the technique of the transmitter applied to a wireless door lock device of a motor vehicle in which a door is automatically locked or unlocked without inserting a key into a keyhole by operating a button or the like provided in the key upon getting on or getting off the motor vehicle. This transmitter ordinarily employs the primary battery as the power source, however, when the primary battery is run out, the piezoelectric element provided as a spare is allowed to generate power to compensate for an inconvenience due to the exhaustion of the battery until the battery is replaced by another battery.

Since the door of the motor vehicle disclosed in the above-described publication is operated immediately before getting on the vehicle or immediately after getting off the vehicle, a signal transmitted from the transmitter is supplied to a receiver provided in the motor vehicle from a relatively near position. That is, in this publication, the transmission that can reach the receiver with a relatively low electric power is presented. Therefore, in the transmitter using the piezoelectric element, in the case of a transmission requiring a relatively high electric power, it has been a problem how the transmitter is constructed.

Further, since a circuit disclosed in the publication does not judge with what quantity of power a capacitor is charged, the circuit is adapted to consume an electric power while it does not recognize whether or not the electric power sufficient for transmission is obtained. Accordingly, under the present condition, since an amount of power generation of the piezoelectric element for one time is small, it is necessary to do an artificial action such as terribly shaking a key for a short time immediately before the transmission. Then, when the amount of power generation is insufficient and the transmission is impossible, an action such as more terribly shaking the key is required. When a user operates the key and decides a transmission state, such actions can be performed. However, in the case of the transmitter which a user does not necessarily operate the key, it has been a problem in what manner the transmitter is constructed.

The use of the piezoelectric element as the power source of the transmitter has been expected as a self-power generation type power source in which a charging operation or an exchanging operation is not necessary. Further, it is demanded to make possible a transmission for communication from a remote place, a transmission requiring a relatively high electric power, or a transmission using a natural force except the artificial action. Therefore, a further improvement has been demanded from the viewpoint that the power generation of the piezoelectric element is efficiently utilized for transmission.

With the above problems taken into consideration, it is an object of the present invention to provide a self-power generation type transmitter in which piezoelectric elements are used as a power source for transmission and generated power is efficiently employed to transmit a signal requiring a relatively high electric power.

### SUMMARY OF THE INVENTION

In order to solve the above-described problems, a self-power generation type transmitter of the present invention utilizes means as described below.

That is, the self-power generation type transmitter defined in claim 1 comprises a power generating part for generating power by applying distortion to piezoelectric elements, a charging part for repeatedly charging generated power and a transmitting part for transmitting a signal by the charged power, in which when an amount of charged power reaches a level at which the signal can be transmitted, the electric power is supplied to the transmitting part from the charging part.

In this device, since the distortion is generated in the piezoelectric element so that the electric power is generated and the charging part is successively charged with the electric power every time the electric power is generated, the amount of charged power in the charging part is increased and stored every time the power generation is repeated. Then, when the amount of charge power stored in the charging part reaches a level at which the signal can be transmitted, the electric power is supplied to the transmitting part. In this case, the signal to be transmitted is a signal transmitted either in air or water or both of them.

Further, according to claim 2, in the self-power generation type transmitter defined in claim 1, the charging part is provided with deciding means for deciding whether or not the amount of charged power reaches the level at which the signal can be transmitted.

In this device, the deciding means is provided so that the electric power is supplied to the transmitting part only when it is decided that the electric power is charged to a level at which the signal can be transmitted.

According to claim 3, in the self-power generation type transmitter defined in claim 2, the deciding means of the charging part decides the amount of charged electric power in accordance with a timing of the power generation of the piezoelectric element.

In this device, since the deciding means decides the amount of charged electric power at a timing which the amount of charged electric power increases due to the power generation of the piezoelectric elements, a wasteful consumption of electric power for decision is reduced.

Further, according to claim 4, in the self-power generation type transmitter defined in claim 2 or 3, the charging part includes discharge switching means for starting a discharging operation when it is decided that the amount of charged power is located at the level which the signal can be transmitted, and stopping a discharging operation when the transmitting part completes the transmission of the signal.

In this device, since the discharge switching means is provided so that the amount of charged power increasing stepwise every time of the power generation of the piezoelectric element is stored without being discharged until the deciding means decides that the amount of charged power reaches a level at which the signal can be transmitted. Further, since the discharge switching means is provided so that when the transmission of the signal is completed and the electric power is not required in the transmitting part, the discharging operation is stopped. Accordingly, the amount of charged power of the charging part is prevented from being wastefully used.

Further, according to claim 5, in the self-power generation type transmitter defined in any one of claims 2 to 4, the power generating part includes the piezoelectric elements and a colliding member which collides with the piezoelectric elements, and the deciding means decides the amount of charged power in accordance with a timing at which the colliding member collides with the piezoelectric elements to generate the power.

In this device, the colliding member collides with the piezoelectric elements to distort the piezoelectric elements and generate electric power, so that the amount of charged power is increased substantially stepwise. Then, the amount of charged power is decided in accordance with a timing of collision of the colliding member, that is, a timing at which the amount of charged power is increased.

Further, according to claim 6, in the self-power generation type transmitter defined in any one of claims 1 to 5, the transmitting part does not transmit a signal until the transmitting part receives an instruction for transmitting a signal after the electric power is supplied to the transmitting part from the charging part.

In this device, the electric power is supplied to the transmitting part from the charging part to bring the transmitting part to a state in which the transmitting part can transmit a signal at any time, and the transmitting part sends a signal when it receives an instruction for transmission. Thus, a timing of transmitting a signal may be controlled based on requirements except the electric power.

### BRIEF DESCRIPTION OF THE DRAWINGS

FIG. 1 is a block diagram of an embodiment (1).

FIG. 2 is a detailed block diagram of the embodiment (1).

FIG. 3 is a circuit diagram of the embodiment (1).

FIG. 4 is a circuit diagram of the embodiment (1).

FIG. 5 is a sectional view of a power generating part of the embodiment (1).

FIG. 6 is a detailed block diagram of an embodiment (2).

FIG. 7 is a circuit diagram of the embodiment (2).

FIG. 8 is a circuit diagram of the embodiment (2).

### BEST MODE FOR CARRYING OUT THE INVENTION

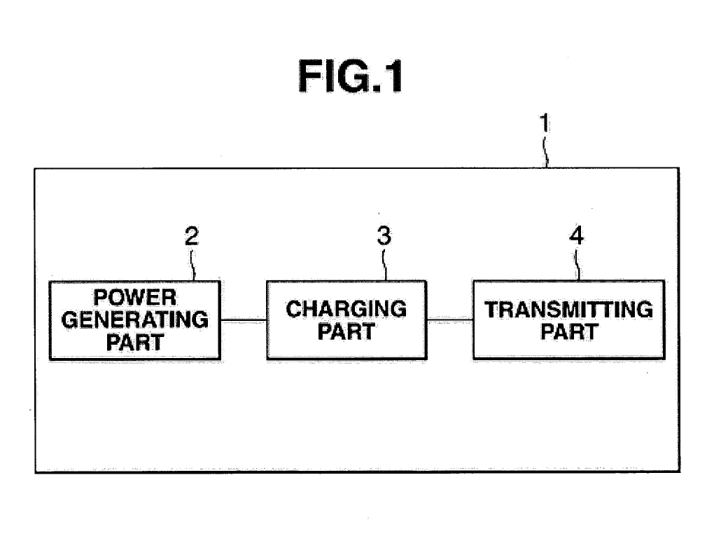

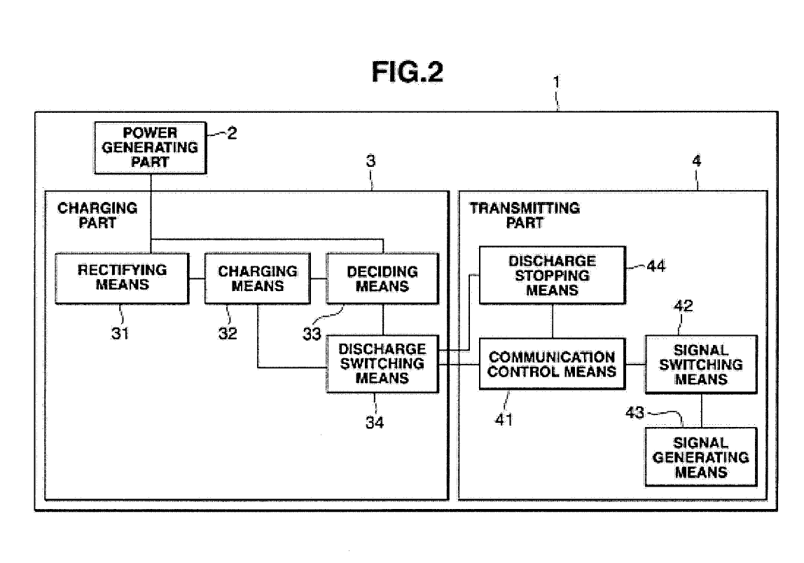

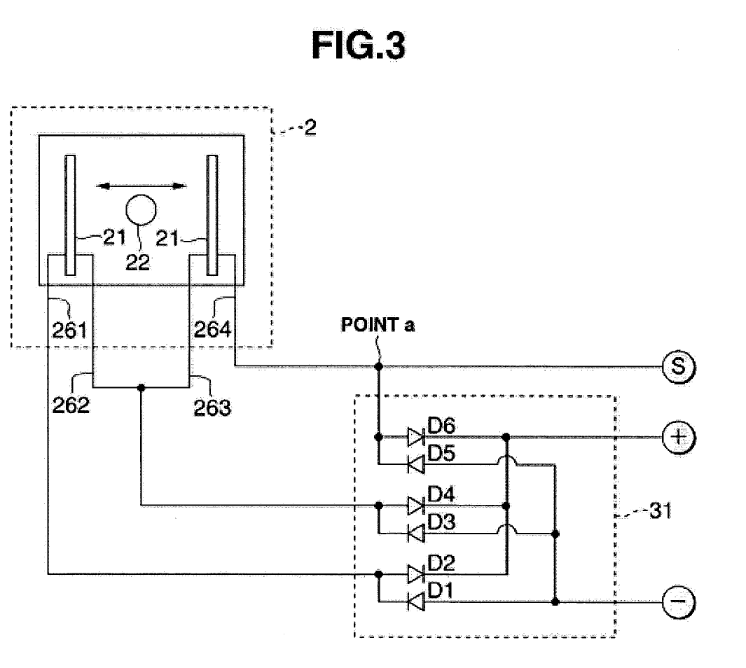

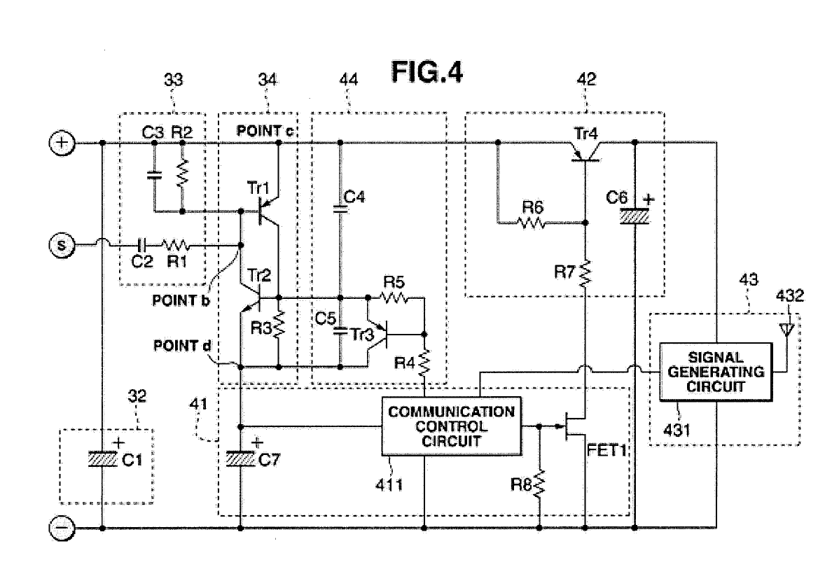

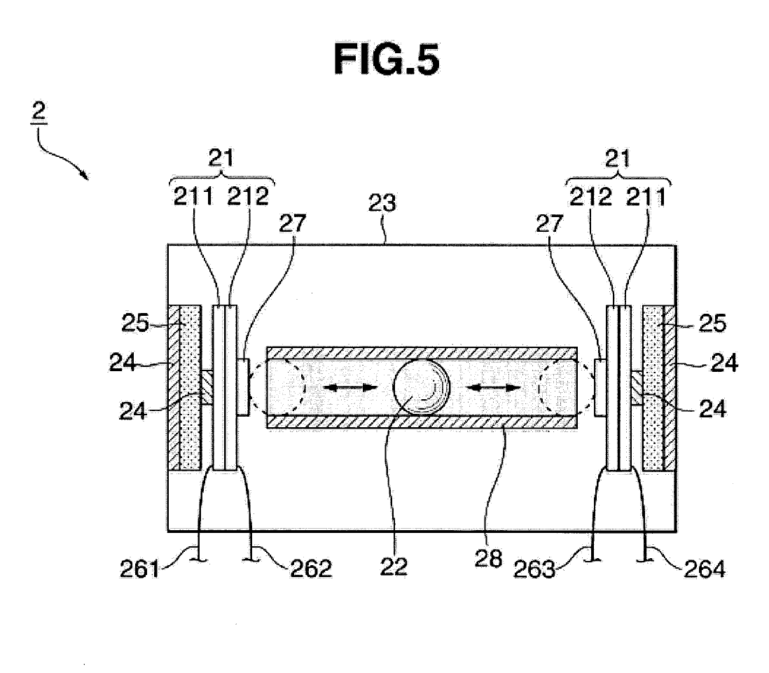

Now, embodiments of a self-power generation type transmitter according to the present invention will be described with reference to the drawings. FIG. 1 is a block diagram of an embodiment (1), FIG. 2 is a detailed block diagram of the embodiment (1), FIGS. 3 and 4 are circuit diagrams of the embodiment (1) and FIG. 5 shows a sectional view of a power generating part.

The self-power generation type transmitter 1 according to the present invention comprises a power generating part 2 for generating an electric power by applying distortion to piezoelectric elements 21, a charging part 3 for repeatedly charging generated power and a transmitting part 4 for transmitting a signal by the generated electric power. When an amount of charged power reaches a level at which a signal can be transmitted, the electric power is supplied to the transmitting part from the charging part.

The power generating part 2 includes the piezoelectric elements 21 and a colliding member 22. When the colliding member 22 collides with the piezoelectric elements 21 to apply a distortion to the piezoelectric element and generate an electric power in the piezoelectric elements 21.

A charging part 3 includes a rectifying means 31, a charging means 32, a deciding means 33 and a discharge switching means 34. The rectifying means 31 rectifies AC power outputted from the power generating part 2 to obtain a pulsating current. The charging means 32 is a means for charging the pulsating current obtained by the rectifying means 31 as a direct current. The deciding means 33 is a means for intermittently monitoring and deciding an amount of charged power of the charging means 32 in accordance with a timing of the power generation of the piezoelectric elements 21. In this means, a small amount of charged power is consumed upon monitoring. However, since the amount of charged power is intermittently monitored, the consumption of the electric power due to a monitor is suppressed and an influence thereof on the amount of charge power is reduced. The discharge switching means 34 is a means for starting the discharging operation of the charging means 32 and supplying an electric power to the transmitting part 4 of a post-stage when the deciding means 33 decides that the amount of charged power of the charging means 32 reaches a level at which a signal can be transmitted.

The transmitting part 4 includes a communication control means 41, a signal switching means 42, a signal generating means 43 and a discharge stopping means 44. The communication control means 41 is a means for carrying out an operation necessary for a communication. The communication control means 41 is started by supplying the electric power thereto from the charging part 3. This means starts its operation to turn ON the signal switching means 42 and supply data for transmitting a signal to the signal generating means 43. The signal switching means 42 is turned ON by the communication control means 41 to supply the electric power to the signal generating means 43. The signal generating means 43 converts the data for transmitting a signal received from the communication control means 41 to a signal and transmits the signal from an antenna 432. The discharge stopping means 44 operates the discharge switching means 34 so as to stop the supply of electric power from the charging part 3. The discharge stopping means 44 is operated by the communication control means 41 when the communication control means 41 completely supplies all the data necessary for transmitting a signal to the signal generating means 43.

Now, the structure of each part will be described in detail by using FIGS. 3 to 5. FIG. 3 and FIG. 4 show continuous circuit diagrams which are connected together by an S point, a+point and a−point.

Initially, in the power generating part 2 as shown in detail in FIG. 5, the colliding member 22 rolling in a housing 23 is adapted to collide with the piezoelectric elements 21 respectively attached to opposed wall sides in the box type housing 23. The colliding member 22 is made of a ball. The piezoelectric element 21 is formed by connecting two PZT piezoelectric ceramic plates 211 and 212 together to have polarizations reverse to each other so that a power generating structure connected in series is obtained. Thus, a cancellation due to the polarization is prevented and a power generation performance is improved. Further, the piezoelectric element 21 is partly stuck only to a central part of a plate type cushion material 25 by an adhesive 24 (may use a fixing method except an adhesive method). The cushion material 25 is fixed to the housing by the adhesive 24. Accordingly, the piezoelectric element 21 is protected from the impact of the collision of the colliding member 22 and the oscillation of the piezoelectric ceramic plates 211 and 212 is continued to improve the power generation performance. Then, to film type electrodes (not shown) formed on the front and back surfaces of the piezoelectric elements 21, lead wires 261 to 264 are respectively connected, and led by the rectifying means 31 of a post-stage. Further, on the surface (a surface with which the colliding member 22 collides) of each piezoelectric element 21, a thin plate type protector 27 for protecting the piezoelectric element 21 from the impact of the colliding member 22 is attached. Further, between the opposed piezoelectric elements 21, a guide 28 is provided for regulating the rolling direction of the colliding member 22 and guiding the colliding member 22 so as to precisely collide with a part to which the protector 27 of the piezoelectric element 21 is fixed. As the guide 28, a cylindrical guide is shown, however, a partition plate may be used.

As the materials of respective parts, materials of lead zirconate titanium are firstly preferably used for the piezoelectric ceramic plates 211 and 212, however, the materials are not limited thereto. The piezoelectric ceramic plates 211 and 212 are desirably made of materials hard as much as possible and having a higher Q value in order to continue the oscillation for a long time and more obtain power generation. Specifically, the Q value is preferably 1000 or higher and more preferably 2000 or higher. As the material of the cushion material 25, a synthetic resin material a rubber material or a soft material obtained by forming them in a sponge shape is preferable. Specifically, foaming polyethylene or the like is preferable. As the material of the colliding member 22, a material heavy enough not to break the piezoelectric elements 21 is good in its power generating efficiency. Specifically, tungsten, iron or the like is preferable. Further, as the material of the protector 27, hard metal, a synthetic resin, etc, is preferable. Specifically, phosphor bronze, stainless steel, etc. is preferable. Phosphor bronze good in its workability is conveniently used.

The structure of the power generating part 2 and the method for generating power of the piezoelectric elements 21 are not limited to the above-description. For example, the structure disclosed in the Japanese Patent Application Laid-Open No. 2001-145375 by the inventors of the present invention may be employed. Further, to a piezoelectric element 21 of a single layer may be stuck a metal plate whose thickness is adjusted so as to balance an amount of distortion and deformation therebetween, and a colliding member 22 may be made to collide with the piezoelectric element from the metal plate side to generate power. Further, a structure that the colliding member 22 is omitted and the both-side supported piezoelectric element 21 is pressed to generate electric power, a structure that a cantilever type piezoelectric element 21 is freely oscillated to generate an electric power or a structure that other distortion forms (wavy forms, etc.) are generated to generate an electric power may be used.

In the rectifying means 31, as shown in FIG. 3, a full-wave rectification circuit is formed by diodes D1 to D6. The AC power outputted in the power generating part 2 is rectified in this circuit and outputted as a pulsating current to the post-stage. The lead wires 262 and 263 of the four lead wires 261 to 264 taken out from the power generating part 2 are connected together, and three lead wires are connected to six diodes D1 to D6. In this case, although the lead wires 262 and 263 are connected together to form a circuit in which the number of diodes is reduced, the lead wires 262 and 263 may not be connected together and the lead wires may be connected to eight diodes to form a full-wave rectification circuit.

The charging means 32 is provided with a capacitor C1. This capacitor may be replaced by a charging battery. The capacitor C1 is successively charged with the pulsating current rectified by the rectifying means 31 as a direct current. Voltage at both the ends of the capacitor C1 is raised every time the colliding member 22 repeatedly collides with the piezoelectric elements 21 to generate an electric power.

As the discharge switching means 34, a self-hold type current switch is employed. In the embodiment (1), a complementary transistor is used and a PNP transistor Tr1 is combined with an NPN transistor Tr2. In the discharge switching means 34, when voltage lower by about 0.6V (a value determined by the Tr1) than the voltage of a point c is applied to a point b, the Tr1 is turned ON and the Tr2 is turned ON at the substantially same time. In such a manner, when the discharge switching means 34 is turned ON, a part between the point c and a point d has an extremely low impedance. Then, the electric power stored in the capacitor C1 of the charging means 32 is charged and supplied to the communication control means 41 with an extremely low loss. This ON-state becomes a self-hold state and is continued until the discharging operation is stopped.

The deciding means 33 includes capacitors C2 and C3 and resistances R1 and R2. C3 is provided for preventing an erroneous operation. The capacitor C2 and the resistance R1 are provided between a point a as an output from the piezoelectric element 21 shown in FIG. 3 and the point b of the discharge switching means 34 shown in FIG. 4. Then, time for applying voltage to the point is determined upon deciding the amount of charged power in accordance with this time constant. In the point a, the AC power is generated every time the colliding member 22 collides with the piezoelectric elements 21. This voltage is a value obtained by adding the forward voltage of the diode D5 to the voltage at both the ends of the capacitor C1. As the voltage of the capacitor C1 is increased due to charging, the AC voltage of the point a is also increased. In other words, in the point a, the AC voltage substantially proportional to DC voltage at both the ends of the capacitor C1 is obtained every time the colliding member 22 collides with the piezoelectric elements 21, that is, intermittently. The AC voltage in the point a is applied to the point b for a very short time determined by the time constant of the resistance R1 and the capacitor C2. The voltage of the point b is determined by the distribution ratio of the resistances R1 and R2. As described above, when the voltage of the point b exceeds the value of voltage lower by about 0.6V (the value determined by the Tr1) than the voltage of the point c, the discharge switching means 34 is turned ON. In this case, since the voltage of the point b is represented by “voltage of a point c×(1−R2/(R1+R2))”, the moment when the voltage of the point b is equal to the voltage lower by about 0.6V than the voltage of the point c “the voltage of the point c—about 0.6V” indicates a threshold value for decision and the level of an amount of charged power is decided based on it. Therefore, the R1 and R2 are adjusted so that an amount of charged power for starting the discharging operation can be adjusted to a level at which a signal can be transmitted. This level is arbitrarily set in accordance with the signal to be transmitted. Here, although the point a is provided in the lead wire 264 side, the point a may be provided in the lead wire 261 side or the side of the connected lead wires 262 and 263. Further, although a decision for transmitting a signal is carried out every time one piezoelectric element 21 of the two piezoelectric elements 21 generates an electric power, the decision for transmitting a signal may be carried out at a timing when both the piezoelectric elements 21 generate electric power, or a decision may be carried out at intervals of n times (n is an arbitrary number) of timings when the piezoelectric elements 21 generate electric power.

The communication control means 41 includes a communication control circuit 411, a capacitor C7, a resistance R8 and an FET1. The capacitor C7 is provided for stabilizing an operation. The resistance R8 and the FET1 are provided as a level conversion for interfacing the communication control circuit 411 and the signal switching means 42 with a low consumed power. When the electric power is supplied to the communication control circuit 411 by the discharge from the charging part 3, a procedure necessary for transmitting a signal is executed in the communication control circuit 411. The communication control circuit 411 is low in its consumed power.

The signal switching means 42 includes a PNP transistor Tr4, resistances R6 and R7, and a capacitor C6. Since a signal generating circuit 431 needs a relatively large power, the signal switching means 42 employs the transistor switch Tr4 for large power to supply the electric power to the signal generating circuit 431. In the signal switching means 42, when a command for starting the transmission of a signal from the communication control circuit 411 turns the transistor Tr4 ON through the FET1 and the resistance R7, the signal generating means 43 operates to start the transmission of a signal.

The signal generating means 43 includes the signal generating circuit 431 and an antenna 432. When the electric power is supplied from the signal switching means 42, the signal generating means 42 converts the data for transmitting a signal received from the communication control circuit 411 into a radio signal and transmits it from the antenna 432. Here, although the radio signal is exemplified, other signals such as a ultrasonic wave signal, an acoustic signal, an infrared ray signal, an optical signal, etc. may be transmitted.

The discharge stopping means 44 includes a PNP transistor Tr3, resistances R4 and R5, and capacitors C4 and C5. The capacitors C4 and C5 are provided for preventing an erroneous operation. In this means, when the communication control circuit 411 completely transmits the data necessary for transmitting a signal to the signal generating circuit 431, a signal for turning the transistor Tr3 ON is outputted through the resistance R4 from the communication control circuit 411. When the transistor Tr3 is turned ON, the self-hold state of the discharge switching means 34 is released to stop the discharging operation of the electric power store in the capacitor C1 and finish a power generating operation.

The operation of the self-power generation type transmitter 1 of the embodiment (1) constructed as mentioned above will be described below. Initially, when the generating part 2 receives an oscillation or the like, the colliding member 22 collides with the piezoelectric elements 21 and the piezoelectric elements 21 receive a distortion to oscillate so that AC power is generated. Since the opposed piezoelectric elements 21 and 21 are provided in the power generating part 2, the electric power is efficiently generated by an oscillation for once. This AC power is rectified in the rectifying means 31 of the charging part 3 to have a pulsating current. The charging means 32 is charged with the pulsating current as a DC current. Then, an amount of charged power of the charging means 32 is gradually increased by repeating the collision of the colliding member 22 with the piezoelectric elements 21.

Every time the colliding member 22 collides with one piezoelectric element 21, the AC power is intermittently generated in the point a. As the amount of charged power of the charging means 32 is increased, the voltage of the point a is also increased. Every time the AC voltage is generated in the point a, the voltage is applied to the point b only for a very short time determined by the time constant of the capacitor C2 and the resistance R1 of the deciding means 33. When the voltage applied to the point b becomes a prescribed value or more, the discharge switching means 34 is turned ON to have a self-hold state, so that the electric power with which the charging means 32 is charged is discharged and supplied to the communication control means 41 of the transmitting part 4 at a stroke.

In the communication control means 41, the communication control circuit 411 to which the electric power is supplied supplies the data for transmitting a signal to the signal generating means 43 and operates the signal switching means 42 to supply the electric power to the signal generating means 43. Thus, the signal generating circuit 431 converts the data for transmitting a signal into a radio signal and transmits it from the antenna 432. On the other hand, when the communication control circuit 411 completely transmits the data for transmitting a signal to the signal generating circuit 431, it turns OFF the signal switching means 42 to stop the supply of the electric power to the signal generating circuit 431. Further, the discharge stopping means 44 is operated to stop the discharging operation by the discharge switching means 34. Thus, in the charging means 32, a charging operation is started again.

As described above, in the self-power generation type transmitter 1 of the embodiment (1), since the electric power generated in the piezoelectric elements 21 is repeatedly accumulated in the charging means 32 and the discharge switching means 34 does not start a discharging operation to a level at which a signal can be transmitted, the electric power does not need to be violently generated for a short period. Therefore, the charging operation can be achieved not only by artificially generating an electric power, but also by generating an electric power using a natural force or the like. Then, every time the piezoelectric elements 21 generate the electric power, the AC voltage is taken out from the output thereof to decide an amount of charged power by using it for the deciding mean 33. Since the above-described intermittent monitor and decision for the amount of charged power are carried out at a timing when the amount of charged power is increased, a decision efficiency is good. In addition, the wasteful consumption of electric power for deciding the transmission of a signal is greatly suppressed, the amount of charged power in the charging means 32 can be increased and the large electric power can be supplied to the transmitting part 4. Further, when the signal is completely transmitted, the discharge from the charging means 32 is stopped, so that an amount of power necessary only for a series of operations for transmitting a signal is consumed and the consumption of the charged power after the transmission is prevented. Accordingly, since the amount of charged power can be increased and the electric power can be efficiently supplied for transmitting a signal even by using the piezoelectric elements 21 having a small amount of power generation, the self-power generation type transmitter of the present invention can be applied not only to a transmission to a near place as described in the prior art, but also to a transmission to a remote plate for communication or a transmission with a large quantity of information as a transmission which requires a relatively high electric power.

In the embodiment (1), although the AC power generated in the point a is used for the deciding means 33 of the self-power generation type transmitter 1, dummy AC power having voltage corresponding to the amount of charged power of the charging means 32 may be generated in place of it and this dummy AC power may be used for decision. As one example, a mechanical switch movable integrally with the power generating part 2 is provided in the charging part 3. One part of the mechanical switch is connected to the positive side of the capacitor C1 of the charging means 32 and the other part of the mechanical switch is connected to the capacitor C2 of the deciding means 33. The mechanical switch is turned ON and OFF every time the power generating part 2 oscillates and voltage at both the ends of the capacitor C1 of the charging means 32 is intermittently applied to the capacitor C2 as dummy AC voltage in accordance with the ON and OFF operation. Then, the voltage is applied to the point b for a very short time determined by the time constant of the capacitor C2 and the resistance R1. Then, when the voltage applied to the point b becomes prescribed voltage or higher, the discharge switching means 34 operates to discharge the power of the charging means 32. In this connection, the dummy AC power may be generated by other methods.

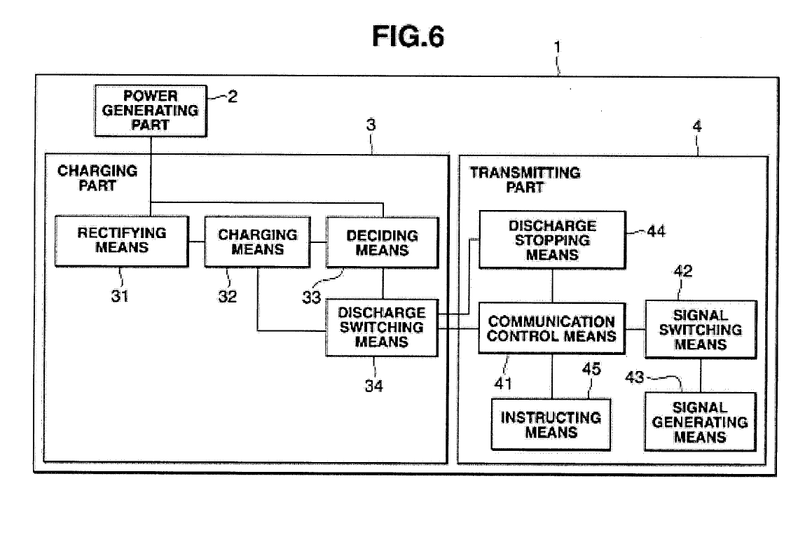

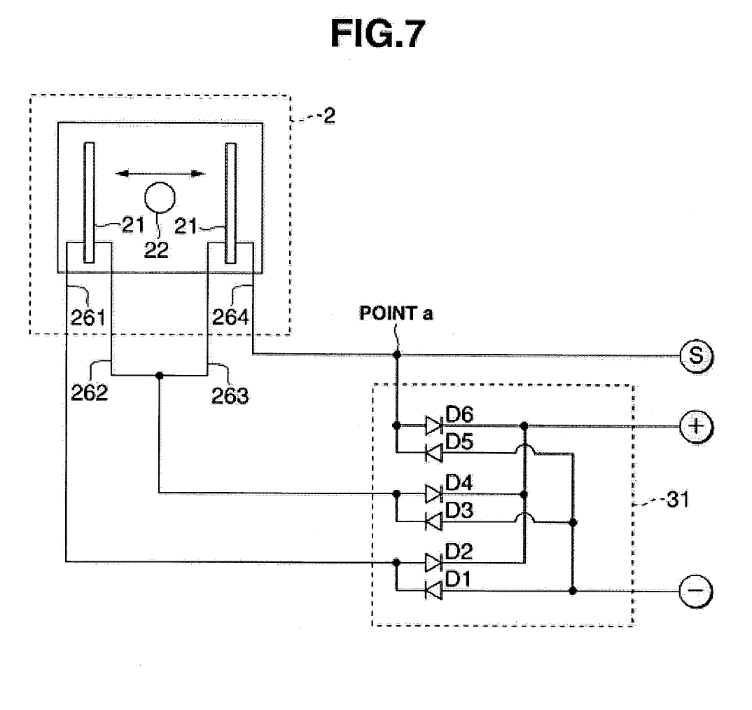

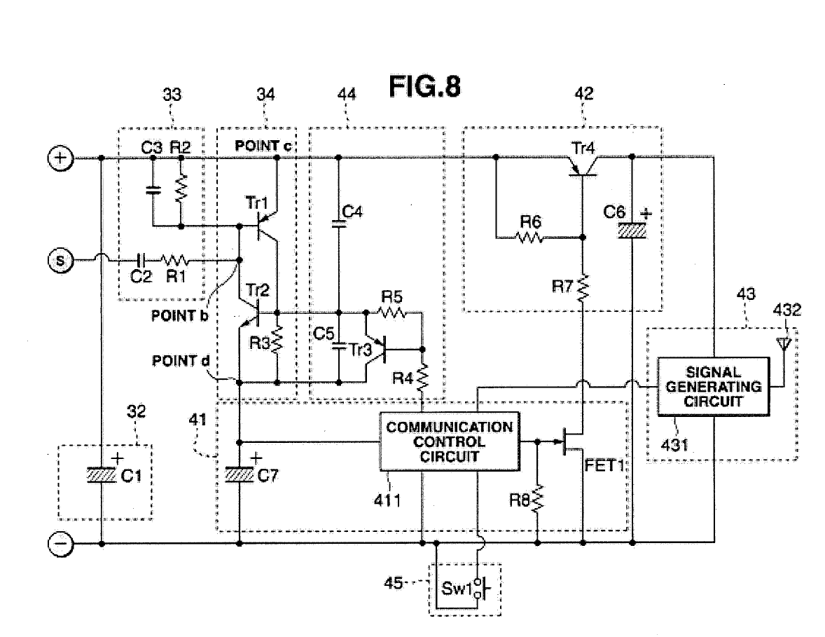

Now, an embodiment (2) of the present invention will be described below. FIG. 6 is a detailed block diagram of the embodiment (2) and FIGS. 7 and 8 are circuit diagrams of the embodiment (2). FIGS. 7 and 8 are continuous circuit diagrams and FIG. 7 is equal to FIG. 3. The same reference numerals are employed in the description the same as that of the embodiment (1) and the detailed description thereof is omitted.

A self-power generation type transmitter 1 of the embodiment (2) is characterized in that a transmitting part 4 transmits a signal at a timing when the transmitting part 4 receives an instruction for transmitting a signal. To the communication control means 41 of the transmitting part 4, an instructing means 45 for instructing a timing for transmitting a signal is connected. The instructing means 45 is provided with a switch Sw1. This switch Sw1 designates a switch turned ON by pressure, temperature or an external signal, or a push-button switch operated by a human being. To the communication control means 41, an instruction for transmitting a signal is supplied thereby. Even while the communication control means 41 receives the supply of electric power from a charging part 3, the communication control means 41 does not operate to transmit a signal until it receives the instruction from the instructing means 45.

With such a construction, since the self-power generation type transmitter 1 of the embodiment (2) does not immediately transmit a signal when an amount of charged power in the charging part 3 reaches a level at which the signal can be transmitted and an electric power is supplied to the transmitting part 4, but it transmits a signal in accordance with the instructing means 45 after the electric power is supplied, the timing of transmission can be controlled. Other operations and effects are the same as those of the embodiment (1).

Industrial Applicability

As specifically described above, the self-power generation type transmitter according to the present invention is a transmitter using the power generation of the piezoelectric elements as a power source, in which repeatedly generated electric power is charged and an electric power is supplied to the transmitting part after the amount of charged power increases to a level at which a signal can be transmitted. Therefore, the generated power can be employed without wastefulness.

Further, since the amount of charged power is decided and efficiently monitored in accordance with the timing of power generation of the piezoelectric elements, the electric power is not wastefully consumed for decision, and while the amount of charged power is monitored, its level can be improved. Thus, the transmission of a signal which requires a relatively high electric power or the transmission of a signal to a remote place can be performed. As a transmitter in which a battery does not need to be replaced by another battery or a charging operation is not required, the transmitter excellent in its utility and profitability and high in its performance can be provided.

1. A self-power generation type transmitter comprising: a power generating part for generating power by applying distortion to piezoelectric elements, a charging part for repeatedly charging generated power and a transmitting part for transmitting a signal by the charged power, wherein when an amount of charged power reaches a level at which the signal can be transmitted, the electric power is supplied to the transmitting part from the charging part.

2. The self-power generation type transmitter according to claim 1, wherein the charging part is provided with deciding means for deciding whether or not the amount of charged power reaches the level at which the signal can be transmitted.

3. The self-power generation type transmitter according to claim 2, wherein the deciding means of the charging part decides the amount of charged electric in accordance with a timing of the power generation of the piezoelectric elements.

4. The self-power generation type transmitter according to claim 2 or 3, wherein the charging part includes discharge switching means for starting a discharging operation when it is decided that the amount of charged power is located at the level where the signal can be transmitted, and stopping a discharging operation when the transmitting part completes the transmission of the signal.

5. The self-power generation type transmitter according to claim 2 or 3, wherein the power generating part includes the piezoelectric elements and a colliding member which collides with the piezoelectric elements, and the deciding means decides the amount of charged power in accordance with a timing at which the colliding member collides with the piezoelectric elements to generate the power.

6. The self-power generation type transmitter according to any one of claims 1 to 3, wherein the transmitting part does not transmit a signal until the transmitting part receives an instruction for transmitting a signal after the electric power is supplied to the transmitting part from the charging part.

7. The self-power generation type transmitter according to claim 4, wherein the power generating part includes the piezoelectric elements and a colliding member which collides with the piezoelectric elements, and the deciding means decides the amount of charged power in accordance with a timing at which the colliding member collides with the piezoelectric elements to generate the power.

8. The self-power generation type transmitter according to claim 4, wherein the transmitting part does not transmit a signal until the transmitting part receives an instruction for transmitting a signal after the electric power is supplied to the transmitting part from the charging part.

9. The self-power generation type transmitter according to claim 5, wherein the transmitting part does not transmit a signal until the transmitting part receives an instruction for transmitting a signal after the electric power is supplied to the transmitting part from the charging part.

10. The self-power generation type transmitter according to claim 6, wherein the transmitting part does not transmit a signal until the transmitting part receives an instruction for transmitting a signal after the electric power is supplied to the transmitting part from the charging part.
